(19) United States
(12) Patent Application Publication
(10) Pub. No.: US 2024/0375314 A1
(43) Pub. Date: Nov. 14, 2024

(54) ACCELERATED CARBONATATION METHOD AND IMPLEMENTATION THEREOF IN A METHOD FOR VALORIZING CONCRETE WASTES AND INDUSTRIAL GASEOUS DISCHARGES

(71) Applicants: VICAT, L'lsle-d'Abeau (FR); FIVES FCB, Villeneuve-d'Ascq (FR)

(72) Inventors: Julien POILLOT, Lyon (FR); Yvan-Pierre JACOB, Pont de Beauvoisin (FR); Hervé GUILLEMIN, Sermerieu (FR); Sami ZELLAGUI, Loos (FR); Alain CORDONNIER, Villeneuve d'Ascq (FR)

(73) Assignees: VICAT, L'lsle-d'Abeau (FR); FIVES FCB, Villeneuve-d'Ascq (FR)

(21) Appl. No.: 18/294,088

(22) PCT Filed: Aug. 1, 2022
(86) PCT No.: PCT/FR2022/051534

§ 371 Date: Jan. 31, 2024

(30) Foreign Application Priority Data
Aug. 2, 2021 (FR) FR21/08401

(51) Int. Cl. B28C 5/38; B28C 9/00; C04B 7/36; C04B 18/167; C04B 20/02

(52) U.S. Cl. CPC B28C 5/388; B28C 9/002; C04B 7/367; C04B 18/167; C04B 20/023

(57) ABSTRACT

An accelerated carbonatation method including the following steps: a) providing recycled concrete granulates with a grain size smaller than or equal to a value V₁ being between 1 mm and 6 mm, in other words a 0/V₁ sand; b) performing on the 0/V₁ sand a separation step by defining a granulometric cut of a determined value V₂ being between 0.1 mm and 0.2 mm so as to obtain: a 1st fraction whose grain size is less than V₂, and a 2nd fraction whose grain size is between V₂ and V₁; c) subjecting the 2nd fraction to an accelerated carbonatation step in a dynamic carbonator so as to obtain carbonated recycled concrete granulates. Also, a method for valorizing concrete wastes and industrial gaseous discharges implementing the accelerated carbonatation method, in particular the gaseous discharges of a cement plant.

The present invention relates to a method for accelerated carbonatation of recycled concrete granulates, as well as the implementation of this method in a method for valorizing these granulates and greenhouse gases emitted by an industrial plant, for example a cement plante.

In France, the demolition of buildings and structures built after the 50 s is nowadays booming and generates 300 million tons of wastes per year, including about 36% of concrete-based materials. In this respect, one should recall that the concrete is a mixture comprising, by weight, about: 80% of mineral inert materials, that is to say the granulates (in different forms: grit, gravel and sand), 15% of a binder (essentially cement) and 5% of water.

Yet, with about 2 tons per person and per year, concrete is the the most consumed manufactured material in the world. The manufacture of concrete currently represents about 40% of the total consumption of granulates. This is why, for economic and environmental reasons, in order to avoid using natural resources as much as possible, it is essential to valorize the wastes of demolition materials, and in particular those based on concrete, so as to obtain recycled concrete granulates which could be perfectly substituted for “natural” granules.

In addition, the concrete-based demolition materials wastes are added to the concrete production scraps, or in other words concrete that is not compliant since it has defects, as well as the concrete surpluses not used on a construction site.

This is why, in the context of the present invention, “recycled concrete granulates” designates concrete granulates originating from: the demolition of structures or buildings containing concrete elements, concrete production scraps, as well as construction site concrete surpluses. The recycled concrete granulates are obtained by crushing and screening existing concrete which may be in the form of blocks and/or rubble. Hence, the recycled concrete granulates are composed of the old natural granulate which is attached to the old cementitious paste. Furthermore, in the granular skeleton of this concrete, the following two fractions types are distinguished:
the “coarse” fraction which contains granulates whose dimensions are larger than 6 mm (or in other words granules with a grain size greater than 6 mm);
the “sand” fraction which contains granulates, the dimensions of which are less than or equal to 6 mm (or in other words granulates with a grain size of less than or equal to 6 mm).

Thus, the wastes of concrete-based materials constitute a considerable raw material that the building industry currently seeks to valorize to make new materials intended for construction, and that being so according to an ecological green circle.

However, for recycled concrete granulates to constitute substitutes for natural granulates, it is essential that the concrete comprising recycled concrete granulates has equivalent mechanical properties, and even better than those of the concrete obtained from natural granulates. Yet, the recycled concrete granulates have a higher porosity at their microstructure which constitutes a technological brake for their use as a substitute for natural granulates. Indeed, this high porosity results in a greater water absorption; which reduces the mechanical properties of the resulting concrete.

Indeed, it is known to overcome this porosity problem by subjecting the recycled concrete granulates to an accelerated carbonatation, namely by subjecting them to a gaseous stream containing carbon dioxide.

In the context of the present invention, “accelerated carbonatation” should be understood as a carbonatation process implemented by a device (in particular a laboratory or industrial device) which therefore differs from natural carbonatation as defined hereinbelow.

During concrete production, the cement reacts with the water so that hydrates of silica and calcium form. These hydrates confer the mechanical strength on the concrete. Yet, these hydrates are not perfectly stable over time: they are naturally carbonated by slowly absorbing atmospheric carbon dioxide and are retransformed into limestone and silica gel. Nonetheless, this natural carbonatation phenomenon occurs very slowly (over several decades) and essentially at the surface of the concrete-based construction material. In addition, the captured amounts of carbon dioxide remain limited, since they do not exceed 15 to 20% of carbon dioxide emissions produced during concrete production.

Since the recycled concrete granulates are composed in part of cementitious paste which therefore contains these hydrates formed during the hydration of the cement, these hydrates can be carbonated when said recycled concrete granulates are subjected to an accelerated carbonatation.

However, the efficiency and the optimization of the accelerated carbonatation (namely its carbon dioxide capture performances having in particular the effect of reducing the porosity at the level of the microstructure of the recycled concrete granulates, as well as its speed of implementation) depend on a large number of parameters such as in particular the grain size of the granulates, the device for setting said granulates into contact with the gaseous stream, the temperature, the humidity and the pressure that should be selected so that this efficiency is as best as possible. Yet, it is not easy to select and combine the good parameters for implementing the accelerated carbonatation in an optimal manner. Therefore, this known technique of accelerated carbonatation is always the subject of intense researches in order to improve its efficiency to valorize not only recycled concrete granulates but also industrial gaseous discharges.

Indeed, many industries, including the cement industry, are bound by the emissions quotas exchange system instituted by the European Union in the context of climate change control. This system is based on an emissions rights capping and exchange principle. A threshold is set to limit the total level of some greenhouse gases emitted by the industries covered by this system. This threshold progressively decreases over the years in order to lower the greenhouse gas emissions. Within the limits of this thresholds, the industries receive or purchase emissions quotas that they can exchange with other industries depending on their needs.

For example, during cement production, the cement plant emits greenhouse gases (namely carbon dioxide) at the clinker production furnace outlet. This is why, taking into account this emission quotas system of the European Union and the constant lowering of the emission threshold, It is essential for the cement plant to valorize its greenhouse gas emissions by implementing technical and ecological solutions which revalorize these carbon dioxide emissions.

Thus, in view of these ecological problems set out hereinabove with regards to the valorization on the one hand of concrete wastes and on the other hand of greenhouse gas discharges, it would be interesting to have an industrial process that could simultaneously and efficiently valorize these two types of solid and gaseous wastes.

In this respect, the application WO 2019/115722 A1 proposes a technical solution which addresses this need, since it describes a method for manufacturing an additional cementitious material which can be substituted for cement from exhaust gases containing carbon dioxide and recycled concrete granulates whose parameter D90 is less than or equal to 1,000 μm (or in other words 90% of these granulates have a grain size less than or equal to 1,000 μm). This method consists in setting said recycled concrete granulates stored in the form of a stack or in a silo in contact with the exhaust gas so as to obtain a carbonated material which is then deagglomerated to obtain said additional cementitious material.

As explained in the patent application WO 2019/115722 A1, it is quite preferable, in order to improve the efficiency and the speed of carbonatation, that the parameter D90 of the recycled concrete granulates is less than or equal to 100 μm. Furthermore, the product obtained upon completion of the method described in this patent application WO 2019/115722 A1 is a cement substitute. Yet, as explained hereinabove, the production of concrete currently representing about 40% of the total consumption of granulates, it would be interesting to transform the recycled concrete granulates into a substitute for the natural granulates in order to avoid using the granulates natural resources.

The Inventors of the present invention have sought to optimize the parameters of the accelerated carbonatation in order to make it more efficient so as to valorize recycled concrete granulates to obtain directly, namely without any additional step such as a deagglomeration step described in the patent application WO 2019/115722 A1, carbonated granulates which are perfectly suitable as substitutes for natural granulates. The Inventors of the present invention have also sought to integrate their accelerated carbonatation method in a method for valorizing the recycled concrete granulates wastes and greenhouse gas discharges, in particular gaseous emissions from a cement plant furnace for clinker production.

Thus, the invention primarily relates to an accelerated carbonatation method which is characterized in that it comprises at least the following steps:
a) providing recycled concrete granulates whose grain size is smaller than or equal to a determined value V₁ which is comprised between 1 mm and 6 mm, in other words a 0/V₁ sand;
b) performing on the 0/V₁ sand a separation step by defining a granulometric cut of a determined value V₂ which is comprised between 0.1 mm and 0.2 mm so as to obtain:
   a 1st fraction whose grain size is less than V₂, in other words a 0/V₂ sand, and
   a 2nd fraction whose grain size is comprised between V₂ and V₁, in other words a V₂/V₁ sand;
c) subjecting the 2nd fraction to an accelerated carbonatation step in a dynamic carbonator by setting said 2nd fraction in contact with a gaseous stream containing carbon dioxide so as to obtain carbonated recycled concrete granulates.

In the context of the present invention, “dynamic carbonator” should be understood an accelerated carbonatation device which is configured so that, during step c) of said method, the 2nd fraction is in movement within said accelerated carbonatation device (for example by means of a lifting and dispersing device) and/or that said accelerated carbonatation device is in movement.

In one embodiment of the invention, the dynamic carbonator includes:
a 1st open end through which the 2nd fraction is introduced,
a 2nd open end through which the gaseous stream containing carbon dioxide is introduced, said 1st and 2nd open ends are separated by a rotary section extending according to a substantially horizontal longitudinal direction and within which the 2nd fraction is advanced from 1st open end to the 2nd open end and the gaseous stream circulates in countercurrent with the advance of the 2nd fraction.

The introduction of the 2nd fraction through the 1st open end may be carried out sequentially or preferably continuously.

In a preferred embodiment of the invention, the section has a cylindrical general shape.

The recycled concrete granulates of step a) consist of a 0/V₁ sand or in other words recycled concrete granulates, whose grain size is comprised between a value close to 0 and a value V₁which may be comprised between 1 mm and 6 mm, preferably between 1.5 and 4 mm, more preferably between 2 mm and 4 mm. As preferred examples of the present invention, the recycled concrete granulates of step a) consist of a 0/2 sand or a 0/4 sand.

The 1st fraction comprises the fraction of the fines of the 0/V₁ sand of step a). More specifically, said fines have a grain size of less than V₂, V₂ being comprised between 0.1 mm and 0.2 mm. In other words, the fines have a grain size comprised between a value close to 0 and about V₂, the value V₂ being excluded.

The 2nd fraction comprises the coarse fraction of the 0/V₁ sand of step a). In other words, the recycled concrete granulates of the 2nd fraction have a grain size comprised between V₂ and V₁, the values V₂ and V₁ being included. The value V₂ is comprised between 0.1 mm and 0.2 mm and the value V₁ is comprised between 1 mm and 6 mm, preferably between 1.5 and 4 mm, more preferably comprised between 2 mm and 4 mm.

Indeed, the Inventors have discovered that by subjecting the 2nd fraction of recycled concrete granulates, or in other words the fraction that is free of the fines of the 0/V₁ sand of step a), to an accelerated carbonatation step in a dynamic carbonator, said accelerated carbonatation was very effective with a high percentage of carbon dioxide capture and thus allowed obtaining carbonated recycled concrete granulates perfectly suited for use as substitutes for natural granulates in concrete production.

The high percentage of carbon dioxide capture has the following effects:
a reduction in the porosity of the microstrucure of the recycled concrete granulates thus carbonated; which allows limiting the absorption of water which is detrimental to the quality of the concrete in which these granulates are incorporated;
a limitation of the decrease in the pH of the concrete in which these granulates are incorporated (or in other words a limitation of the acidity of the concrete); this allows limiting the corrosion of the steels of the reinforced concrete structures.

Thus, the concrete obtained with these granulates has excellent mechanical properties. More 15 specifically, the carbonated recycled concrete granulates obtained with the accelerated carbonatation method according to the invention confer on the concrete in which they are incorporated a good compressive strength, good durability properties, in particular good resistance against corrosion of the steel reinforcements which are contained in the concrete, said corrosion being caused by chloride ions and carbon dioxide.

The Inventors have, quite surprisingly, discovered that the selection of a granulometric cut at a determined value V₂ comprised between 0.1 mm and 0.2 mm so as to extract the part of the fines from the 0/V₁ sand, promotes exchanges between the remaining recycled concrete granulates (in other words the 2nd fraction) and the gaseous stream during the accelerated carbonatation step within the dynamic carbonator and thus improves carbon dioxide capture. This discovery of the extraction of the portion of the fines for the accelerated carbonatation of recycled concrete granulates goes against general knowledge in the considered technical field, and in particular the teaching of the aforementioned patent application WO 2019/115722 A1, which recommend favoring fractions of recycled concrete granulates with the smallest grain size (in other words the fine fractions) in order to implement the accelerated carbonatation.

Thus, during the accelerated carbonatation step c) during which the selected recycled concrete granulates (i.e. the 2nd fraction) are brought into contact with the gaseous stream containing carbon dioxide, the carbonatation reaction of the residual cementitious paste in these granulates occurs.

The exchanges between the recycled concrete granulates and the carbon dioxide are promoted when the dynamic carbonator includes a 1st open end and a 2nd open end which are separated by a section extending according to a substantially horizontal longitudinal direction as described hereinabove. In this embodiment of the invention, said rotary section advantageously has a downward inclination oriented in the direction of advance of the 2nd fraction which is comprised between 0.5° and 8°, more preferably between 1° and 5°. Quite preferably, the downward inclination is 2°.

The rotary section may be a substantially inclined cylinder having a 1st open end for the introduction, sequentially or preferably continuously, of the 2nd fraction of recycled concrete granulates and a 2nd open end for the introduction of a gaseous stream containing carbon dioxide. The cylinder is set in rotation to allow blending of the bed of material consisting of the 2nd fraction, as well as its advance in the cylinder. This bed of material is swept by the gaseous stream which therefore advances in countercurrent with the advance of the bed of material.

Advantageously, in order to increase the exchange surface between the 2nd fraction of recycled concrete granulates and the gaseous stream, the cylinder is equipped at its inner surface with a device for lifting and dispersing the recycled concrete granulates within said cylinder. This device is perfectly within the reach of a person skilled in the art.

Other technical features of the dynamic carbonator and of the accelerated carbonatation step are described hereinafter.

The dynamic carbonator of step c) may consist of a rotary drum dryer (namely a perfectly known device used in many industrial sectors, including that of construction materials) which has been adapted for the implementation of the accelerated carbonatation as described just above. In other words, the present invention can be implemented with a rotary drum dryer which has been adapted so as to obtain a dynamic carbonator having the technical features described just above, as well as those described hereinafter. Examples of rotary drum dryers that could be used in the context of the present invention are in particular those of the TSM range commercialized by the company Marini-Ermont or those with an enclosure of the TTD range commercialized by the company Allgaier.

Thus, the invention relates to the use of a rotary drum dryer for the implementation of an accelerated carbonatation on recycled concrete granulates with a gaseous stream containing carbon dioxide.

The recycled concrete granulates of the 0/V₁ sand of step a) may originate from the demolition of structures or buildings containing concrete elements, concrete production scraps or construction site concrete surpluses. Thus, it may consist of concrete blocks and/or rubble, possibly reinforced with a steel structure, which are subjected to different successive steps (or where appropriate sometimes simultaneous) of:
sorting in order to extract the steel materials,
crushing, and
screening,
   until obtaining the desired 0/V₁ sand of recycled concrete granulates.

The sorting step may be carried out with a scrap iron separation system comprising an electromagnet designed for drawing the steel elements combined with a magnetic strip for scrap iron separation.

For example, the crushing may comprise a primary crushing step implemented by a crushing device which comprises:
a reception hopper, for example with a volume in the range of 15 m³, fed by a loader made of recycled concrete materials and with a block size less than or equal to 500 mm;
a vibrating feeder;
a primary crusher of the jaw or impact type configured to produce recycled concrete materials, whose block size is less than or equal to a value comprised between 60 mm and 200 mm,
an output conveyor.

This crushing device may possibly be equipped with a scrap iron separation system as described hereinabove.

Afterwards, the recycled concrete materials whose block size is less than or equal to a value comprised between 60 mm and 200 mm thus obtained may be subjected to a secondary crushing step so as to obtain recycled concrete materials with a grain size less than or equal to 20 mm. This secondary crushing step may be implemented in a second crushing device which comprises for example:
a system for grit removal by screening;
a gyratory crusher performing a crushing of the concrete materials so as to obtain the grain size less than or equal to 20 mm.

The recycled concrete materials thus obtained may be subjected to one or more screening step(s) until obtaining a 0/V₁ sand. These screening steps are carried out in screening devices perfectly within the reach of a person skilled in the art.

More generally, obtaining a 0/V₁ sand of recycled concrete granulates from concrete blocks and/or rubble derived from demolitions and/or dismantling of dwellings or structures, production scraps or construction site surpluses, is perfectly within the reach of a person skilled in the art.

For example, the separation step b) may be carried out in a defillerization loop which consists of a flash drying system associated with a dynamic separator. Setting of the dynamic separator allows defining the granulometric cut to a determined value V₂ which is comprised between 0.1 mm and 0.2 mm.

Of course, the separation step b) of the accelerated carbonatation method is perfectly within the reach of a person skilled in the art and may also be carried out in a device suited for the separation different from the defillerization loop described hereinabove just as an embodiment of step b).

The stay time in the dynamic carbonator of the 2nd fraction may be comprised between 15 minutes and 12 hours. In an advantageous embodiment of the invention, this stay time is one hour.

In the embodiment of the invention wherein the dynamic carbonator includes a 1st and a 2nd open ends which are separated by a rotary section extending according to a longitudinal direction substantially horizontal as described hereinabove, the rotational speed of said rotary section is advantageously comprised between 0.5 rpm and 10 rpm.

Preferably, the temperature of the gaseous stream containing carbon dioxide is comprised between 15° C. and 90° C.

The volume percentage of carbon dioxide in said gaseous stream is comprised between 3% and 100%. In one embodiment of the invention, the gaseous stream contains only carbon dioxide.

Advantageously, the 2nd fraction of recycled concrete granulates may be moistened before step c) of the carbonatation method according to the invention, preferably with a moisture content not exceeding 12%. In other words, if the 2nd fraction is moistened, its moisture content is advantageously lower than or equal to 12%. In the embodiment of the invention wherein the dynamic carbonator includes 1st and 2nd open ends which are separated by a rotary section extending according to a substantially horizontal longitudinal direction, the dynamic carbonator may comprise, at the level of the 1st open end, a water injection pipe configured to moisten the 2nd fraction before implementation of step c).

Furthermore, the relative humidity within the dynamic carbonator is advantageously comprised between 50% and 100%.

The moisture content of the 2nd fraction, as well as the relative humidity within the dynamic carbonator as described hereinabove, are suitable for the optimization of the accelerated carbonatation step c), namely an improvement in the reaction kinetics and the percentage of carbon dioxide capture.

The gaseous stream containing carbon dioxide may consist of industrial gaseous discharges, preferably gaseous discharges from a cement plant.

This is why the present invention also relates to a method for valorizing recycled concrete granulates and industrial gaseous discharges which is characterized in that it implements the accelerated carbonatation method as described hereinabove and in that the gaseous stream containing carbon dioxide consists of industrial gaseous discharges, preferably gaseous discharges of a cement plant.

Thus, thanks to the valorization method according to the invention:
the recycled concrete granulates are revalorized into carbonated recycled concrete granulates which, as explained hereinabove, are perfectly suitable as substitutes for natural granulates to be implemented in concrete formulations;
the gaseous industrial discharges are valorized because they are used during step c) of the accelerated carbonatation method.

Preferably, the industrial gaseous discharges are gases derived from a cement plant furnace, more preferably from a furnace for clinker production.

In one embodiment of the invention, the industrial gaseous discharges are treated so as to obtain treated gases, the carbon dioxide content of which has been increased compared to that of the initial industrial gaseous discharges. The treated gases thus obtained may be stored, for example in a cement plant, before implementation thereof in the accelerated carbonatation method according to the invention.

In one embodiment of the valorization method according to the invention, the 1st fraction, in other words the 0/V₂ sand, with a grain size of less than V₂ (i.e. the fines), V₂ being comprised between 0.1 mm and 0.2 mm, is used in the manufacture of a clinker. These fines are particularly suitable, because it consists of a decarbonated material which avoids the decarbonatation of the natural limestone.

In other words, the method for valorizing the recycled concrete granulates and industrial gaseous discharges allows valorizing not only the 2nd fraction with a grain size comprised between V₂ and V₁ in order to obtain carbonated recycled concrete granulates upon completion of the accelerated carbonatation which are perfectly suitable as substitutes for natural granulates to be implemented in concrete formulations, but also the 1st fraction with a grain size less than V₂ which is a decarbonated material very suited to the clinker formulation.

The invention will be better understood from the detailed description which is set out hereinbelow with reference to the appended drawing representing, as a non-limiting example, a diagram of a plant implementing the method for valorizing recycled concrete granulates and industrial gaseous discharges according to the invention, as well as experimental results implementing an accelerated carbonatation according to the invention.

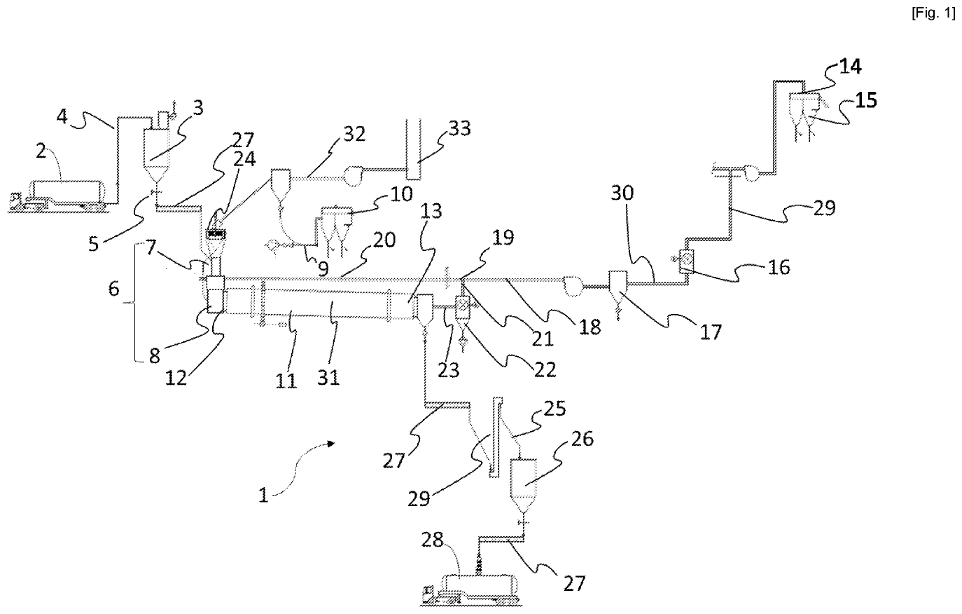

FIG. 1 is a schematic representation of a plant implementing the method for valorizing recycled concrete granulates and industrial gaseous discharges according to the invention.

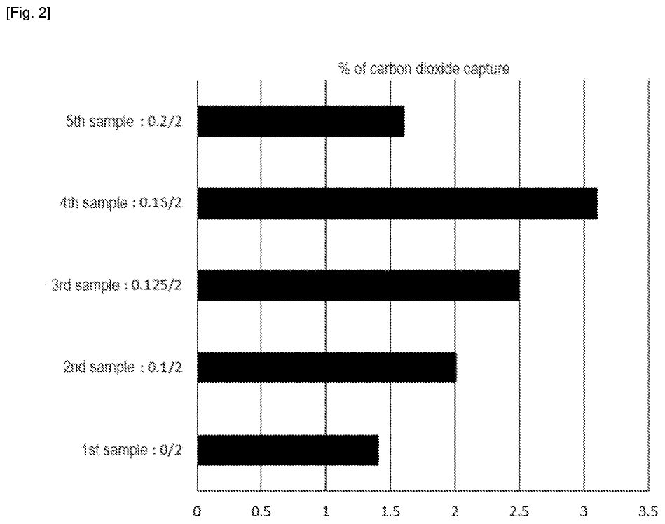

FIG. 2 is a histogram of the percentage of carbon dioxide capture obtained from 5 experimental samples comprising sands of different grain sizes.

FIG. 1 schematically represents a plant 1 which implements the method for valorizing recycled concrete granulates and industrial gaseous discharges according to the invention. A truck 2 delivers to the plant 1 a sand of recycled concrete granulates with a grain size less than or equal to 2 mm (in other words a sand 0/2). This 0/2 sand is conveyed up to a silo 3 thanks to a 1st conveying system 4.

The plant 1 has a valorization annual capacity of 15,000 tonnes of 0/2 sand. For this purpose, it is continuously fed with 0/2 sand, at a rate of about 2 tons/hour.

The silo 3 comprises at its base an extraction system 5 which is configured to:
feed 0/2 sand a defillerization loop 6 via a worm screw 27,
as well as adjust the flow rate of said defillerization loop 6 in 0/2 sand.

The defillerization loop 6 is broken down into a dynamic separator 7 and a flash drying system 8. The defillerization loop 6 is configured to:
separate the 0/2 sand into a 1st fraction, so-called 0/0.15 sand with a grain size of less than 0.15mm and a 2nd fraction, so-called 0.15/2 sand with a grain size comprised between 0.15 mm and 2 mm, and
dry these two fractions.

More specifically, setting of the dynamic separator 7 allows defining a granulometric cut of a determined value V₂ which is comprised between 0.1 mm and 0.2 mm. In the present case, the value V₂ has been set at 0.15 mm.

Upon completion of the separation step, the 1st fraction represents, in weight percentages, about 20% (i.e. 0.4 ton/hour) and the 2nd fraction 80% (i.e. 1, 6 ton/hour).

Afterwards, the 1st fraction thus obtained and which is therefore dry is conveyed thanks to a 2nd pneumatic conveying system 9 towards a furnace 10 of a cement plant for clinker production. In this manner, the fines of the 0/2 sand fraction are revalorized in the furnace 10 of a cement plant as a decarbonated material highly suited to the formulation of clinkers.

The 2nd fraction (which is therefore also dry) is moistened such that its moisture content is 4% before introduction thereof at the 1st open end 12 of a dynamic carbonator 11 which further includes a 2nd open end 13. Said 1st and 2nd open ends 12, 13 are separated by a rotary section 31 which has a cylindrical general shape with a length of 6.5 m and a diameter of 1.3 m. The humidification of the 2nd fraction may be carried out with an injection pipe not shown in FIG. 1. Thanks to the rotation of the rotary section 31 of the dynamic carbonator 11 at a speed of 1.5 rpm, the 2nd fraction advances from the 1st end 12 to the 2nd end 13 of said dynamic carbonator 11. This thus allows blending the bed of material consisting of the 2nd fraction and its advance within the rotary section 31 of the dynamic carbonator 11.

The rotary section 31 further has a downward inclination of 2 which is oriented in the direction of advance of the 2nd fraction within said rotary section 31.

The stay time of the 2nd fraction in the dynamic carbonator 11 is about one hour.

In addition, a gaseous stream containing a mixture which comprises, in volume percentages: 23% of carbon dioxide, 5% of dioxygen, 65% of dionitrogen and 7% of water steam, is injected at the level of the 2nd end 13 of the dynamic carbonator 11. Its origin is explained in more detail hereinafter. This gaseous stream is at a temperature of 55° C. and has a flow rate of 2,000 m³/h. The relative humidity within the dynamic carbonator 11 is 75%.

Thus, the 2nd fraction is swept by the gaseous stream which circulates in countercurrent with the advance of the 2nd fraction within the rotary section 31 of the dynamic carbonator 11. In order to increase the exchange surface between the 2nd fraction and the gaseous stream, the rotary section 31 is equipped at its inner surface with a device for lifting and dispersing the 2nd fraction (not represented in FIG. 1).

A gaseous stream at a flow rate of 6,000 m³/hour is drawn from the outlet 14 of a clinker production furnace 15 of a cement plant. The composition of this gaseous stream, in volume percentages, is as follows: 23% of carbon dioxide, 5% of dioxygen, 65% of dionitrogen and 7% of water steam. The temperature of this gaseous stream is 350° C. This gaseous stream is conveyed with a 3rd conveying system 29 up to a cooling device which consists of an atomization system 16 comprising nozzles for atomizing air and water so as to be cooled to a temperature of 150° C. Afterwards, this gaseous stream is conveyed with a 4th conveying system 30 up to a bag filter 17 in order to be dedusted. Afterwards, this gaseous stream is conveyed with a 5th conveying system 18 up to an intersection point 19 from which:
a 1st portion of this gaseous stream having a flow rate of 4,000 m³/hour is conveyed with a 6th conveying system 20 up to the defillerization loop 6 to be injected therein, and
a 2nd portion of this gaseous stream having a flow rate of 2,000 m³/h is conveyed with a 7th conveying system 21 in a cooling device 22 consisting of an air-air heat exchanger to cool it to a temperature of 55° C. Afterwards, the gaseous stream thus cooled is conveyed with an 8th conveying system 23 up to the 2nd end 13 of the dynamic carbonator 11. This consists of the gaseous stream which is introduced into the dynamic carbonator 11 for the implementation of the accelerated carbonatation and which has been described hereinabove.

Afterwards, the remaining gases upon completion of the accelerated carbonatation and the gases used in the defillerization loop 6 are collected at the outlet 24 of the dynamic separator 7 in order to be dedusted, then conveyed thanks to a 9th conveying system 32 up to a cement plant furnace 33 in order to be reintroduced into the gases of said furnace 33.

In this plant 1, the gaseous stream flow rate feeding the dynamic carbonator 11 is in excess with respect to the maximum potential of capture of carbon dioxide by the recycled concrete granulates. Thus, the plant 1 contribures to the valorization of a portion of the gaseous discharges of the cement plant furnace 15. Indeed, 470 kg of carbon dioxide have been produced per produced cement ton. If the cement plant produces one million tons of cement a year, the accelerated carbonatation plant 1as described which is capable of carbonating 15,000 tons/year of 0/2 sand, contributes to a reduction in the range of 0.08% of cabon dioxide emissions of this cement plant.

The major interest of the plant 1 lies in the valorization of the recycled concrete granulates into carbonated recycled concrete granulates which are perfectly suitable as substitutes for the natural granulates to be implemented in concrete formulations.

The recycled concrete granulates obtained upon completion of the accelerated carbonatation are discharged at the 2nd end 13 of the dynamic carbonator 11 in order to be conveyed, via a worm screw 27 up to a bucket elevator 29, then introduced into a storage silo 26 via a connecting duct 25.

The recycled concrete granulates are conveyed via a worm screw 27 up to a truck 28 in order to be transported outside the plant 1.

### EXPERIMENTAL PART

Experiments have been carried out in order to demonstrate the impact on the percentage of carbon dioxide capture of samples consisting of recycled concrete granulates in which the fines have been extracted upon completion of an accelerated carbonatation, as well as the properties of concretes obtained with these carbonated samples.

### 1st Series of Experiments

In a 1st series of experiments, a 0/2 sand obtained after crushing recycled concrete granulates originating from a demolition of a building has been subjected to separation steps consisting of 4 air-jet sievings according to the standard NF EN 993-10 with the following granulometric cuts: 0.1 mm, 0.125 mm, 0.15 mm and 0.02 mm so as to prepare the 5 following samples:
a 1st sample containing the initial 0/2 sand fraction;
a 2nd sample containing a 0.1/2 sand fraction;
a 3rd sample containing a 0.125/2 sand fraction;
a 4th sample containing a 0.15/2 sand fraction;
a 5th sample containing a 0.2/2 sand fraction.

The mass of each of the samples was 500 g.

The 5 samples have been subjected to an accelerated carbonatation for one hour in a dynamic carbonator consisting of a laboratory mortar mixer made tight and equipped with a gas circulation system, as well as a heating system. The conditions were as follows:
the gaseous stream was a mixture of 25% vol. of carbon dioxide, 70% vol. of dioxygen, 0.3% vol. of nitrogen dioxide and 500 ppm of sulfur dioxide at a temperature of 55° C.;
a moisture content of the samples of 4.5%;
a relative humidity within the mixer of 95%;
a mixing speed of 10 rpm.

Upon completion of this accelerated carbonatation, 5 carbonated samples have thus been obtained. In other words, the capture of carbon dioxide by the 5 samples during this accelerated carbonatation has allowed obtaining 5 carbonated samples.

The percentage of carbon dioxide capture of each of the 5 samples has been determined with a carbonate bomb by performing an attack with hydrochloric acid on each of the samples 1 to 5 before and after the accelerated carbonatation and by measuring the pressure induced by the release of the carbon dioxide resulting from this acid attack. By “percentage of carbon dioxide capture of a sample”, it should be understood the ratio of the mass of carbon dioxide captured by said sample to the mass of said sample.

More specifically, the following protocol has been implemented:
0.8 g of the sample to be analyzed have been transferred into the reaction vessel of the carbonate bomb;
5 mL of a 5% by volume of calcium acetate solution have been added into the container;
5 mL of a 37% by volume of hydrochloric acid solution have been gently poured into the reaction vessel;
the carbonate bomb has been slowly stirred for a period comprised between 1 and 10 minutes.

The carbon dioxide released during the acid attack of the carbonates has increased the pressure within the carbonate bomb.

Table 1 hereinbelow details the percentage of carbon dioxide capture for each of the 5 samples.

TABLE 1

| Sample No. | 1 | 2 | 3 | 4 | 5 |
|---|---|---|---|---|---|
| % of carbon dioxide | 1.4 | 2 | 2.5 | 3.1 | 1.6 |
| capture | | | | | |

FIG. 2 is a histogram of the percentages of the carbon dioxide capture of the samples No. 1 to 5.

In view of Table 1 and FIG. 2, it could be reported that with identical accelerated carbonatation conditions:
The samples No. 2 to 5 have a better carbon dioxide capture than the sample No. 1. This shows the impact on the efficiency of the accelerated carbonatation when the fines with a grain size less than a determined value V₂ which is comprised between 0.1 mm and 0.2 mm have been extracted from the 0/2 sand fraction.
The best carbon dioxide capture (3.1%) is obtained with the sample No. 4, namely with the 0.15/2 sand or in other words a fraction which has been obtained from the 0/2 sand by removing the fines with a grain size of less than 0.15 mm. This percentage of carbon dioxide capture is much higher than that of the 0/2 sand which is 1.4%.

### 2nd Series of Experiments

In a 2nd series of experiments, the 0/2 sand has been subjected to an accelerated carbonatation under the same conditions as for the 1st series of experiments with the sole exception that the laboratory mortar mixer has remained static. Hence, the accelerated carbonatation has been performed statically without stirring the 0/2 sand.

After one hour, the percentage of carbon dioxide capture was 0.8% and after two hours, it was 1%.

Thus, this 2nd series of experiments shows the beneficial impact on the percentage of carbon dioxide capture when the carbonator is dynamic or in other words set in motion. Indeed, this promotes the exchanges between the recycled concrete granulates and the gaseous stream.

### 3rd Series of Experiments

In a 3rd series of experiments, the samples No. 1 and 4 respectively containing the 0/2 sand and the 0.15/2 sand have been subjected to accelerated carbonatation for 28 days in the same laboratory mortar mixer as that of the 1st and 2nd series of experiments and which has remained static. The conditions were as follows:
the gaseous stream was a mixture of 3% vol. of carbon dioxide and of 97% vol. of air at a temperature of 20° C.;
an initial moisture content of the samples of 5%;
a relative humidity within the carbonatation chamber of 65%.

The percentage of carbon dioxide capture for the sample No. 1 was 2.8% and that of the sample No. 4 was 3.6%.

This 3rd series of experiments also shows the positive effect on the efficiency of the accelerated carbonatation when the fines were extracted from 0/2 sand.

### 4th Series of Experiments

In a 4th series of experiments, a sample No. 6 and a sample No. 7 have been prepared. The sample No. 6 contained 0/4 sand obtained after crushing recycled concrete granulates originating from a demolition of a building. This 0/4 sand has been subjected to a separation step consisting of an air-jet sieving according to the standard NF EN 993-10 with a granulometric cut of 0.15 mm so as to obtain the sample No. 7 with a 500 g mass which contains 0.15/4 sand.

The samples No. 6 and 7 have been subjected to an accelerated carbonatation for one hour in the same laboratory mortar mixer as that of the previous series of experiments, and that being so under the same accelerated carbonatation conditions as those of the 1st series of experiments.

The percentage of carbon dioxide capture for:
the sample No. 6 (0/4 sand) was 2.3%;
the sample No. 7 (0.15/4 sand) was 3.6%.

This 4th series of experiments also demonstrate the beneficial effect on the percentage of carbon dioxide capture, when the fines (in other words the recycled concrete granulates with a grain size of less than 0.15 mm) have been extracted from the 0/4 sand.

### 5th Series of Experiments

During this 5th series of experiments, the properties of a concrete prepared with the carbonated sample No. 2 of the 1st series of experiments (in other words a 0.1/2 sand which has been carbonated) have been compared with those of a concrete prepared from a conventionally used natural sand.

More specifically, for this 5th series of experiments, there have been used:
the carbonated sample No. 2 of the 1st series of experiments;
a carbonated sample No. 2′.

The carbonated sample No. 2′ has been obtained from a different 2nd 0/2 sand, at its physico-chemical properties, from that opne used for the 1st series of experiments, as it is obtained after crushing recycled concrete granulates originating from a demolition of a building of different origin.

This 2nd 0/2 sand has also been subjected to a separation step which consisted in sieving by air jet according to the standard NF EN 993-10 with a 0.1 mm granulometric cut so as to obtain a sample No. 2′ containing a sand fraction 0.1/2.

The sample No. 2′ has been subjected to an accelerated carbonatation under the same conditions as those of the sample No. 2 and which are described in the 1st series of experiments so as to obtain the carbonated sample No. 2′.

### Preparation of the Concretes No. 1 to 3

Three concretes (concrete No. 1, concrete No. 2 and concrete No. 3) have been prepared according to a conventional concrete production process.

More specifically, the concrete No. 1 has been prepared in particular with sands and natural granulates.

The concrete No. 2 has been prepared with the same composition of sands and natural granulates as the concrete No. 1, with the exception that 30% of the mass of natural sands have been replaced by sand of the carbonated sample No. 2.

The concrete No. 2 has been prepared with the same composition of sands and natural granulates as the concrete No. 1, with the exception that 30% of the mass of natural sands have been replaced by sand of the carbonated sample No. 2′.

### Properties of the Concretes No. 1 to 3

Given the amount of natural sands substitued in the concretes No. 2 and No. 3 by the carbonated sand, namely sand originating respectively from the carbonated samples No. 2 and No. 2′, as well as the level of carbon dioxide which has been captured during the accelerated carbonatation during the preparation of these carbonated sands of the carbonated samples No. 2 and No. 2′, The concretes No. 2 and No. 3 have a carbon balance reduced by 10.8% and 8.5% respectively relative to that of the concrete No. 1.

The concretes No. 2 and No.3 do not have the same percentage of carbon balance reduction. This is explained by the aforementioned different origins of the 0/2 sands that have been used to obtain the carbonated samples No. 2 and No. 2′. The 2.3% discrepenacy in percentage is not surprising given the different origins of the two 0/2 sands and therefore their physical-chemical properties differences. Thus, it could be reported that the sample No. 2 has captured more carbon dioxide than the sample No. 2′ during the accelerated carbonatation.

The compressive strength of the concretes No. 1 to 3 has been measured according to the standard NF EN 12390 3 on 11×22 cm test samples after 7 and 28 days of wet curing at 20° C.

Table 2 hereinbelow details the compressive strength (expressed in MPa) at 7 days and 28 days for the concretes No. 1 to 3.

TABLE 2

| | Compressive strength | Compressive strength |
|---|---|---|
| | after 7 days (MPa) | after 28 days (MPa) |
| Concrete No. 1 | 29 | 36.5 |
| Concrete No. 2 | 29.1 | 36.4 |
| Concrete No. 3 | 28.8 | 37.3 |

In view of Table 2, it could be reported that the compressive strength of the concretes No. 2 and No. 3 is equivalent to that of the concrete No. 1. After 7 days, the compressive strength of the concretes No. 2 and No. 3 is very close to that of the concrete No. 1 and after 28 days, the compressive strength of the concrete No. 3 is slightly better than that of the concrete No. 1.

Thus, these laboratory experiments show that the concretes obtained from sands some of the natural sands of which have been substituted by carbonated sands obtained upon completion of an accelerated carbonatation performed on sands with a grain size 0.1/2 (in other words sands in which the fines with a grain size of less than 0.1 have been extracted) have mechanical properties equivalent to those of the concretes obtained from natural sands.

These experiments demonstrate that the method of accelerated carbonatation of recycled concrete granulates is an effective solution to obtain recycled concrete granulates that are perfectly suitable as substitutes for natural granulates to be implemened in concrete formulations.

1. An accelerated carbonatation method comprising the following steps:
a) providing recycled concrete granulates whose grain size is smaller than or equal to a determined value V₁ which is comprised between 1 mm and 6 mm, in other words a 0/V₁ sand;
b) performing on the 0/V₁ sand a separation step by defining a granulometric cut of a determined value V₂ which is comprised between 0.1 mm and 0.2 mm so as to obtain:
a 1st fraction whose grain size is less than V₂, in other words a 0/V₂ sand, and
a 2nd fraction whose grain size is comprised between V₂ and V₁, in other words a V₂/V₁ sand;
c) subjecting the 2nd fraction to an accelerated carbonatation step in a dynamic carbonator (41) by setting the 2nd fraction in contact with a gaseous stream containing carbon dioxide so as to obtain carbonated recycled concrete granulates.

2. The accelerated carbonatation method according to claim 1, wherein the concrete granulates recycled from the 0/V₁ sand of step a) originate from the demolition of structures or buildings containing concrete elements, concrete production scraps or construction site concrete surpluses.

3. The accelerated carbonatation method according to claim 1, wherein the stay time of the 2nd fraction in the dynamic carbonator is comprised between 15 minutes and 12 hours.

4. The accelerated carbonatation method according to claim 1, wherein the temperature of the gaseous stream containing carbon dioxide is comprised between 15° C. and 90° C.

5. The accelerated carbonatation method according to claim 1, wherein the volumetric percentage of carbon dioxide in said the gaseous stream is comprised between 3% and 100%.

6. The accelerated carbonatation method according to claim 1, wherein the 2nd fraction is humidified before step c) with a moisture content lower than or equal to 12%.

7. The accelerated carbonatation method according to claim 1, wherein the relative humidity within the dynamic carbonator is comprised between 50% and 100%.

8. The accelerated carbonatation method according to claim 1, wherein the dynamic carbonator includes:
a 1st open end through which the 2nd fraction,
a 2nd open end through which the gaseous stream containing carbon dioxide is introduced,
the 1st and 2nd open ends are separated by a rotary section extending according to a substantially horizontal longitudinal direction and within which the 2nd fraction is advanced from the 1st end to the 2nd end and the gaseous stream circulates in countercurrent with the advance of the 2nd fraction.

9. The accelerated carbonatation method according to claim 8, wherein the rotary section has a downward inclination oriented in the direction of advance of the 2nd fraction which is comprised between 0.5° and and 8°.

10. The accelerated carbonatation method according to claim 8, wherein the rotational speed of the rotary section of the dynamic carbonator is comprised between 0.5 rpm and 10 rpm.

11. A method for valorizing recycled concrete granulates and industrial gaseous discharges, wherein it implements the accelerated carbonatation method according to claim 1 and wherein the gaseous stream of carbon dioxide consists of industrial gaseous discharges.

12. The valorization method according to claim 11, wherein the industrial gaseous discharges are gases derived from a cement plant furnace.
